(19) United States
(12) Patent Application Publication
(10) Pub. No.: US 2025/0186951 A1
(43) Pub. Date: Jun. 12, 2025

(54) VENTING REINFORCED MEMBRANE, ESPECIALLY INTENDED FOR THE PROTECTION OF MEMS PACKAGES, MANUFACTURING METHOD THEREOF AND DIE CUT PART MADE WITH SUCH VENTING MEMBRANE

(71) Applicant: SAATI S.P.A., APPIANO GENTILE (CO) (IT)

(72) Inventors: Paolo CANONICO, APPIANO GENTILE (CO) (IT); Elisa GRIMOLDI, APPIANO GENTILE (CO) (IT); Matteo GRIMOLDI, APPIANO GENTILE (CO) (IT); Carmine LUCIGNANO, APPIANO GENTILE (CO) (IT); Franco MERLETTI, APPIANO GENTILE (CO) (IT); Marco MIETTA, APPIANO GENTILE (CO) (IT); Omar SAONCELLA, APPIANO GENTILE (CO) (IT)

(21) Appl. No.: 18/855,478

(22) PCT Filed: Apr. 11, 2023
(86) PCT No.: PCT/IB2023/053671

§ 371 Date: Oct. 9, 2024

(30) Foreign Application Priority Data
Apr. 12, 2022 (IT) 102022000007241

(51) Int. Cl. B01D 69/02; B01D 53/22; B01D 67/00; B01D 69/10; B01D 71/64; B32B 5/02; B32B 27/12; H04R 1/08

(52) U.S. Cl. CPC B01D 69/02; B01D 53/228; B01D 67/0013; B01D 67/0016; B01D 67/0088; B01D 67/009; B01D 69/1071; B01D 71/64; B32B 5/024; B32B 27/12; B01D 2325/0231; B01D 2325/02834; B01D 2325/04; B32B 2250/02; B32B 2262/02; B32B 2305/026; B32B 2307/7376; H04R 1/086

(57) ABSTRACT

A venting composite membrane, a corresponding manufacturing method, and a component obtained with the same are disclosed. The venting membrane includes a supporting woven fabric made of woven polymeric monofilaments, and a membrane attached to said supporting fabric, wherein said supporting woven fabric is at least partly embedded in said membrane, and said membrane is a polymeric membrane having a coagulated porous microstructure.

### FIELD OF THE INVENTION

The present invention relates to a venting device having a reinforced membrane, especially intended for the protection of MEMS devices, and to a die cut part containing such venting device.

### BACKGROUND ART

As known, in many technological fields, there is a need to provide for venting devices which are permeable to gaseous fluids, typically air, while preventing the passage of other fluids, dust or other small particle elements.

A specific field to which reference will be made below is that of consumer electronics, but this is not to be considered as limiting the application of the present invention, which can be advantageously used in fields (medical devices, sealed containers, automotive, . . . ) where it is necessary to design a venting device which offers good protection from external agents, while ensuring acoustic (low-frequency) or signal permeability, high mechanical performances, and heat resistance.

The consumer electronics field is peculiar because it makes wide use of small sensors to equip various devices, such as smartphones or tablets. Such sensors, typically based on MEMS (Micro Electrical Mechanical System) architecture, are intended for measuring acoustic (e.g., microphones), physical (e.g., accelerometers), or environmental (e.g., temperature and pressure sensors and their gradients) quantities. Although some types of MEMS do not need a direct connection with the outside, and therefore can be suitably sealed, many others need instead an unobstructed path through which external perturbations can reach the inside. To the second category belong, for example, microphones, which have their own dedicated acoustic port on smartphones, and ambient pressure sensors (which can also be used as altimeters/variometers), which similarly need to be connected to the external atmosphere through a dedicated opening in the device body.

FIG. 1 is a schematic perspective view of an exemplary smartphone with water-resistance properties (IP68 waterproof category). On one edge of the smartphone casing a plurality of openings is provided which give access to the electronic devices behind them; for example, a ambient pressure sensor MEMS is located at the opening 101, while MEMS microphones are located at the openings 102.

The openings on said smartphone casing must be suitably shielded with barriers which are permeable to air and pressure but prevent at least dust penetration.

In the majority of devices, and particularly smartphones, the sensor ports consist of holes with a diameter of 1-2 mm, which are normally protected by a metal mesh or a synthetic fabric with open mesh which ensure a certain level of protection against larger contaminants (>100 microns), but fail to protect against micrometric particles (typically smaller than 5 microns), as well as against pressurized water intrusion.

Since smartphone manufacturers increasingly require to be enabled to make waterproof devices according to the IPx7-x8 standard, i.e., capable of withstanding even immersion in water to a certain depth (typically from 1 to 10 meters for 30 seconds), shielding problems becomes considerably more complicated: it is in fact necessary to prevent the external liquid from penetrating through the sensor port and reaching the MEMS sensor itself thus damaging it.

Protecting MEMS from the intrusion of external liquids, as well as solid contaminants (dusts), is an urgent need in such type of application, even if it shall not be achieved at the expense of the sensor sensitivity and responsiveness.

Similar criticalities already arise during the manufacturing and assembly of the MEMS sensor itself inside the electronic device, phases wherein there is a risk of intrusion of particles or liquids. In said steps of the assembling process, the MEMS sensor, which is not yet integrated in the device, and typically without protection, is subjected to a reflow soldering process and other operations, which involve exposure to high temperatures and to solid and even liquid contaminants (flux, solder paste): there is therefore a real risk that such substances penetrate into the MEMS port, which typically is 0.5-1 mm in size. On the other hand, it is normally not possible to close said opening during the process, both for accessibility reasons and because a vent need to be left for the heated air to expand inside the MEMS cavity. All of this currently leads to a certain percentage of waste in production due to contamination.

Said processing phase is extremely critical for the venting filter, as it occurs at high temperatures: the reflow process involves standardized thermal cycles, with a peak of 260° C. for 40 s to be repeated thrice. Obviously, survival to reflow cycles is a strict requirement for a protection device to be integrated on the MEMS circuit since the beginning of manufacturing.

In the state of the art, solutions to protect MEMS microphones have already been proposed, consisting of acoustic membranes which ensure suitable protection and sound transmission. In particular, MEMS devices used as microphones can be protected by self-standing membranes of stretched PTFE or in the form of nanofibers.

Such solution is not entirely satisfactory both on the side of heat resistances and that of mechanical behaviour. In particular, said membranes are not appropriate for MEMS pressure or ambient sensors, because the aforementioned materials, which are vibrating and have a strongly reactive acoustic behaviour, would be too sensitive to the high-frequency disturbances of a dynamic pressure stress. Not even when the membranes are supported by nonwoven fabrics are they a complete solution to the above needs, because their discontinuous configuration can originate preferential paths for air leakage (with loss of performance of the sensor) or even an entrance for liquids in the presence of waterproof requirements.

Therefore, for critical venting needs, especially for the protection of MEMS ambient sensors, an optimal solution does not yet exist.

This type of application requires simultaneously meeting various needs, both in terms of manufacturing a specific membrane and in terms of assembled component, which needs have not been currently satisfactorily addressed on the market yet.

As regards the protection of a device during its use, such needs are:
protection against intrusion of splashes/jets of water or other liquids (IPx4-x5 level);
waterproofing in case of immersion (level IPx7-x8, depth 1-10 μm of H₂O for a period >30 minutes);
protection against intrusion of solid particles; given the delicacy of MEMS sensors, the critical size threshold for such contaminants is down to 5 microns.
furthermore, considering the functional requirements, each protective element placed between the MEMS sensor and the external environment should in any case guarantee a sufficient air passage; therefore, among the requirements to be met, there is also an air permeability feature suitable for transferring the pressure signal into the cavity wherein the MEMS sensor itself is installed, guaranteeing at least the typical values indicated below.

At the assembly level, as already mentioned, it is required to ensure the expansion of the internal air overheated during the reflow process.

At the level of intended use, instead, the protective component air permeability directly affects the MEMS pressure sensor performance. In fact, any pressure sensor measures the pressure inside its cavity which is corresponding to the pressure outside the venting device only after a sufficient time for pressure equalisation. Since the equalization of the internal and external pressures involves the transfer of a small volume of air, the interposed venting material permeability affects said flow: a high air permeability of any protective material allows to minimize the response time of the MEMS sensor and to keep it aligned with the desired design specifications.

Depending on the system geometry (volumes involved and venting device area) and the desired reaction time, the venting device itself should have an air permeability value typically within the range of 5-50 L/m² at 1 kPa of pressure.

It should be noted that the required performance of this measuring system is more complex than the simple reproduction and measurement of the pressure signal. Actually, a reduction of the high-frequency components of the external stresses which are not connected to sudden changes in the environment, but rather to disruptive factors, such as overpressures due to turbulence in the vicinity of the device, pressure waves generated by medium frequency sounds, or possible very intense and short sound pulses which have nothing to do with the magnitude of interest is desired. In all such cases it is important that the venting material placed to protect the MEMS also functions as a low-pass filter, largely cutting the components of the pressure signal above the maximum frequency of interest, which in any case is always relatively low.

In this regard, protective venting devices with a more reactive behaviour, such as unsupported vibrating membranes, have shown to end up transmitting an undamped high-frequency pressure signal, if said frequency is close to the protective venting device own resonance frequency.

A series of solutions currently exist, which differ from each other in the used technology, but still are not satisfactory in the context described above. Here are some significant examples.

### Synthetic or Metal Fabric

Precision fabrics of synthetic (made from polymers which resist the high temperatures typical of reflow cycles) or metallic monofilaments can be used to protect the MEMS cavity. By selecting a suitable filament diameter (preferably from 24 to 100 μm) and a suitable number of filaments/threads, it is in fact possible to adapt the venting device permeability to the desired values, for example to ensure a rapid pressure equalization and therefore minimize the sensor response time. An example of this technology is described in EP2566183 in the name of the same Applicant.

Current technological limits, however, do not allow to obtain on a regular basis openings with characteristic size lower than 5 μm, therefore it is not possible to guarantee a filtration efficiency of 99.99% of particles in the range of 1-5 μm.

Additionally, for those applications where waterproof to a water column of 1 m for 30 minutes (IPX7) or >1 m for 30 min (IPX8, preferably >5 m for 30 minutes) is required, said fabrics are not functional. As a matter of fact, even considering surface treatments apt to minimize the material surface energy, the characteristic opening >1 μm would allow passage of water at much lower pressures than 100 mbar. Ultimately, this class of protective venting devices is currently incapable to achieve the IP67/68 waterproofing class.

### Stretched PTFE or Nanofiber Membrane

Thin (<300 μm) unsupported membranes, obtained by stretching (such as those materials named ePTFE) or electrospinning of heat resistant polymers, can be manufactured with pores smaller than or equal to 1 μm. In this way better performances against particles intrusion (99.99% 1-5 μm) as well as protection against pressurized liquids intrusion can be obtained. However, unsupported membranes with thickness <300 μm, even up to <100 μm, have reduced stiffness values, which lead to a reactive behaviour to the passage of air. As already mentioned, these membranes are likely to transmit high-frequency pressure signals without dampening them, if said frequency is close to the protective venting device own resonance frequency, thereby impairing the sensor reading.

Supported (not-Embedded) PTFE or Nanofiber Membrane

Supported membranes are obtained by stretching (ePTFE) or electrospinning of heat resistant polymers, and subsequent lamination on a support layer, such as fabric or synthetic non-woven fabric, metal fabric, perforated film or other. An example of this technology is described in EP2561131 in the name of the same Applicant.

These membranes make it possible to overcome the problem associated with high-frequency vibrations, but involve other problems connected to the assembly of the membrane. The venting component is in fact mounted at the opening of the MEMS by use of adhesive circular (acrylic or silicone based) rims placed between the protective venting device and the MEMS cavity. In this way, the membrane support layer is not sealed on its perimeter and, since it cannot be waterproof itself, it may cause side leakage from the outside into the MEMS sensor package. Therefore, although this type of solution is useful for overcoming the problem of a reactive behaviour of some types of membranes, it has the drawbacks that it can no longer meet the waterproof requirement (IPX7.8).

Polyimide Film A last known solution provides for the use of films of synthetic heat resistant material (in particular PI and PEEK polymers, e.g., Kapton® films manufactured by DuPont). While on the one hand this family of venting devices is exceptional from the point of view of protection against the intrusion of liquids and particulates, on the other hand it fails to guarantee any air permeability as it is a non-breathable continuous film. This feature is a problem both for the MEMS process phase (expansions due to heating) and for the ambient sensor operation.

As can be understood from the above, there is currently no optimal solution still which meets all the process and function requirements for a venting device to protect MEMS sensors such as ambient sensors and similar applications.

### SUMMARY OF THE INVENTION

An object of the present invention is therefore to provide a venting device which can be especially used for the protection of MEMS sensors, which overcomes the limits of the prior art.

This object is achieved by means of a reinforced membrane for venting devices, and of a die cut part containing said membrane, as described in their essential features in the attached claims.

The proposed innovation relates to a hybrid venting device consisting of a polymeric membrane obtained by phase inversion on a support layer—preferably a heat resistant polymeric monofilament fabric—which is partly or totally embedded in the membrane itself.

The support layer function is to reinforce and stiffen the membrane in a controlled way, resulting in a purely reactive behaviour to the passage of air through the medium, and avoiding as much as possible resonance or uncontrolled vibration phenomena, while having a porous structure with very small pores but high permeability.

The support layer is at least partly embedded in the membrane and it is integral therewith, which guarantees excellent workability of the venting device, avoids problems of delamination between the membrane and the support layer and, above all, does not affect the waterproofness of the component assembled on the MEMS sensor package port by means of an adhesive circular rim.

The membrane is obtained from a polymer suitably selected to resist the high temperatures involved in the reflow soldering cycle. Since the membrane must have a very small pore size to guarantee a good level of protection against the intrusion of particles and pressurized liquids, but it must also be sufficiently open to guarantee an appropriate level of air permeability, the membrane is characterized by sufficiently small pores—in particular <5 μm to guarantee protection against particles, 1 μm to guarantee waterproof to a pressure of 1 meter water columns, <1 μm to guarantee waterproof to higher pressures—but at the same time by a high degree of porosity (given as a ratio of pore volume versus material volume) of at least 40% of the volume of the membrane.

To further ensure resistance to the intrusion of water or any other liquid, its surface energy need to be << with respect to the surface tension of the liquid considered. According to a preferred embodiment, together with pore sizes in the order of or smaller than 1 μm, the reinforced membrane according to the invention is also subjected to a treatment, preferably a vacuum coating, capable of generating a low surface energy <20 mN/m, preferably <10 mN/m, to repel liquids with low surface tension (see oils or alcohol, 30-35 mN/m and 22-30 mN/m) returning contact angle values >90° with the aforementioned liquids, and to withstand the intrusion of pressurized water, 100 mbar or >500 mbar, returning contact angle values >120° and preferably >130°.

According to another aspect of the innovation, an assembled component is also provided, obtained from a multilayer die cut part, with a built-in adhesive for the assembly, combined with a reinforced membrane based on synthetic monofilament fabric, combined with a hydrophobic surface treatment to ensure the desired degree of waterproofness.

In particular, the invention refers to a die cut part suitable in size for installation on a MEMS sensor. Given the typical size of 0.5 to 1 mm of a MEMS port, a multilayer die cut part with a size of the active area of 0.8-2 mm is provided, said active area exposing the reinforced, porous membrane with hydrophobic treatment.

Outside said active area a rim of double pressure sensitive adhesive (PSA) is provided, covering an external diameter of 2-3.5 mm. Such adhesive is preferably non-porous and arranged to perfectly seal the volume between the hydrophobic reinforced membrane and the MEMS port itself, thus avoiding side leakage, and ensuring a watertight seal and heat resistance consistent with the application of reflow.

In general, the total thickness of the assembled device can vary from 60 to 300 microns, with ideal values in the range of 80-150 microns. The thickness of the adhesive on the face towards the MEMS sensor determines the inner volume between reinforced membrane and MEMS port, and therefore the response time for the pressure measurement. Due to air permeability, the thickness values suggested above allow to minimize the sensor response time.

Depending on the geometry of the MEMS sensor package, the presence of a second layer of adhesive on the reinforced membrane opposite side may be required, keeping said membrane in the middle of a sandwich configuration, so as to permanently seal also the coupling of the membrane itself with a package external channel. Alternatively, said channel should in any case be equipped with compressible gaskets apt to perfectly seal the reinforced membrane during the final assembly.

Finally, if an even better flexural stiffness is desired for the reinforced membrane, a further rigid ring of continuous plastic material (stiffener) can be fitted into the die cut part, accompanied by a further layer of double PSA for its assembly.

The die cut part can have a circular shape or a square, rectangular, oval, or other simple convex shape, provided the active area is equivalent to the circular surface having the sizes indicated above.

In the prior art some other contributions have been given for porous membranes and filters. For example, US 2012/223014, WO 2017/014130, US 2017/128876, US 2019/052945 by the same applicant, KR 2009 0116564, WO 2021/083162 and US 2020/055006.

### BRIEF DESCRIPTION OF THE DRAWINGS

Further features and advantages of the solution of the present invention will in any case become more evident from the following detailed description of some preferred embodiments thereof, provided purely by way of non-limiting example and illustrated in the attached drawings, wherein:

FIG. 1, as already mentioned, is a diagrammatic perspective view of an exemplary smartphone;

FIG. 2 is a schematic view of the manufacturing process according to the invention;

FIG. 3A is a schematic view of a “Slot die” technique;

FIG. 3B is a schematic view of a “Blade coating” technique;

FIGS. 4A-4C represent schematic enlarged cross-sectional views of a reinforced membrane according to the invention;

FIG. 5 is an electron microscope view of a section of the venting device according to the invention;

FIG. 6 is an enlarged plan view of the porous structure of the membrane according to the invention;

FIGS. 7A and 7B are plan and sectional views, respectively, of a die cut part consisting of a reinforced membrane according to the invention with a PSA rim for installation on a “top port” MEMS sensor package;

FIGS. 8-11 are plots of the complex acoustic impedance as a function of the frequency, of the die cut part of the invention compared to a prior art example, both with an active area diameter of 1.6 mm;

FIG. 12 is a plot showing the tensile stress stiffness values of some materials of the prior art (self-standing membranes made of nanofibers and PTFE), compared with the supported, heat resistant, hydrophobic membrane of the invention;

FIGS. 13A-13E are schematic views of possible installation of the die cut parts according to the invention, variously coupled with PSA rims and/or stiffening rings on a “top port” or “bottom port” of MEMS sensor packages.

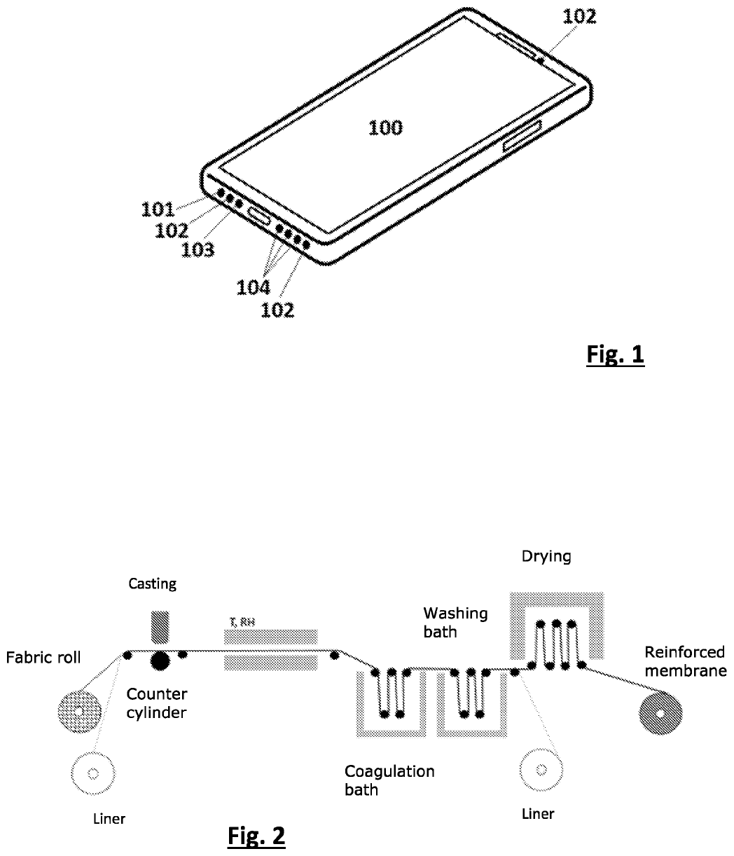

### DETAILED DESCRIPTION OF THE PREFERRED EMBODIMENTS

Through extensive experimentation, the Applicant has identified a novel configuration of a composite device, in particular a reinforced membrane which has proved to be extremely effective for satisfying the requirements cited above, especially suitable as a protective device for MEMS sensor packages.

In particular, a protective venting device includes a support layer formed by a monofilament fabric of synthetic material based on a polymer selected from PEEK, PEK, PEKK, PTFE, PI, PFA, FEP, PPS, PEI, PBI, PCTFE, ECTFE, PAT, PPSU. According to a particularly advantageous version, the preferred polymer is PEEK, as it offers high heat resistance, excellent mechanical properties, and excellent chemical inertness.

The percentage of open area of the fabric (ratio between open area of meshes and area occupied by filaments/threads) must be greater than 30% and preferably greater than 50%, but still smaller than 75% in order to avoid problems of dimensional stability and flatness of the fabric, as well as excessive reduction of stiffness.

The square or rectangular mesh woven fabric is preferably a fabric with plain wave mesh, but also different interlacing between warp and weft filaments having open area ratio less than 50% can theoretically be used: for example twill weave 2/1, or 3/1, or 4/1 etc or twill weave 2/2 or panama. The fabric is made with polymeric monofilament, i.e., a filament/thread extruded and stretched in a single strand. Such type of monofilament, unlike common multifilament yarns, is characterized, by its very nature, by extreme uniformity of physical-geometric properties which lead to a greater dimensional uniformity of the final fabric (thickness, mesh opening, open area) which is advantageous for the effectiveness of the resulting composite product and on the manufacturing process (membrane deposition) which will be described later. Other advantageous features for the outcome of the composite product are an high elastic modulus, which aids to obtain a high stiffness, and a low specific weight which allows to maintain a reduced overall weight of the composite product.

The fabric thickness (for example measured according to the IS05084 standard) of this woven support layer is in the range of 40-120 μm, preferably 40-70 μm, with an individual monofilament thickness of 30-40 μm, in order to obtain sufficient flexural stiffness of the fabric.

According to the invention, a protective venting device is obtained from the woven support layer embedded in a porous polymeric membrane obtained through a phase inversion process.

In particular, the porous membrane which partly or completely embeds the support layer of monofilament fabric is obtained by casting, through a phase inversion process.

The phase inversion or coagulation process to obtain porous membranes is known per se, but according to the invention a specific method is provided which allows a reliable embedding of the polymeric monofilament fabric and the development of peculiar features of the resulting composite device.

Referring to FIG. 2, an exemplary diagram of a manufacturing plant of the composite device according to the invention is shown.

A starting solution of the phase inversion process consists of at least one polymer and one solvent. In particular, it includes a heat resistant polymer, any process additives to alter the solution viscosity, any useful additives for dyeing the membrane, any organic and inorganic additives acting as pore-forming agents, any useful additives for conferring specific surface properties, and a solvent or mixture of solvents capable of putting in solution the used polymer or mixture of polymers.

According to a preferred embodiment of the invention, as the polymer of the solution polyimide (PI) is used. Alternatively, S-PEEK, PES, S-PES, PPS, PAI, PBI and solubilisable fluorinated polymers can be selected, depending on the specific chemical and heat resistance required.

According to a preferred embodiment of the invention, a water-soluble solvent for polyimide resins is used, such as Rodhiasolv® Polarclean HSP manufactured by Solvay, which offers “green” features. Alternatively, solvents or solvent mixtures selected from N-methyl-2-pyrrolidone (NMP), N-ethylpyrrolidone (NEP), N,N-dimethylformamide (DMF), N,N-dimethylacetamide (DMAc), dimethylsulfoxide (DMSO), Dihydrolevoglucosenone (Cyrene), Rodhiasolv® Polarclean HSP, γ-butirrolactone (GBL), ethyllactate, triethylphosphate (TEP), gammavalerolactone (GVL), dimethyllactamide, Tamisolve® NxG, acetonitrile, N,N-dimethyllactamide (DML) can be also used.

In the starting solution the polymer (particularly polyimide) concentration by weight can be as high as 25%, but it has been showed that the preferable results are obtained with a concentration of 6-12% by weight. Accordingly, the solvent moiety can be as high as 75%, but preferably between 94% and 88%.

The solution can include additives such as PEG, PEO, PVP, SiO₂, metal oxides and hydroxides, carbon black, UV absorbers, HALS (hindered amine light stabilizer), which can be added in a weight percentage from 0.1 to 10%. In the preferred version, a functionalized carbon black is added in a percentage from 2 to 8%, and UV absorber and HALS are added in a percentage from 0.1 to 2%.

The starting solution viscosity may range from 300 to 10,000 cP, but experimentation has led to identifying the most advantageous range between 500 and 2,000 cP to advantageously carry out the casting process on the woven support layer. In order to keep the viscosity in the desired range, the solution temperature during the spreading phase is kept at 20-100° C., preferably 20-60° C.

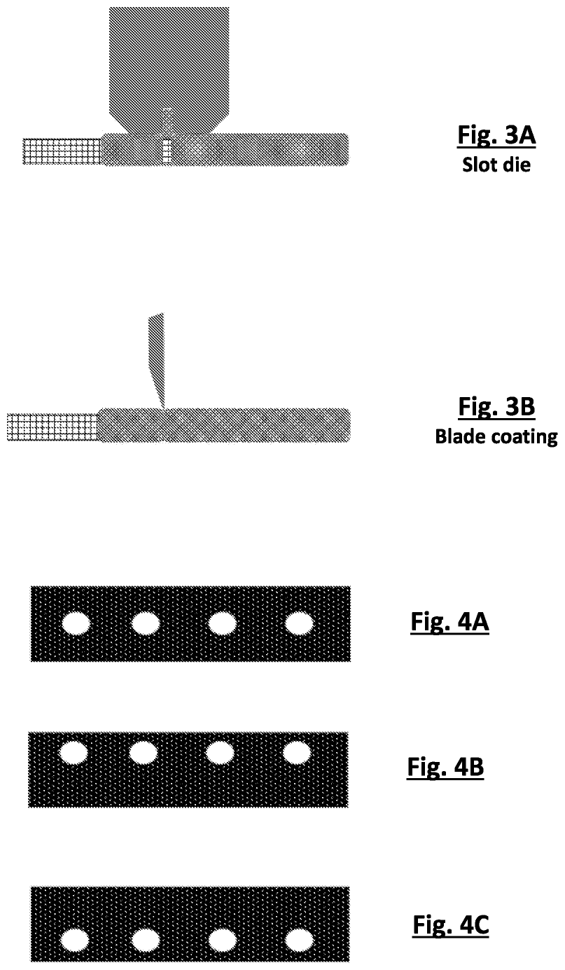

The monofilament fabric described above is embedded with the starting solution by casting in the first part of the manufacturing plant (see FIG. 2), using a “slot die” (FIG. 3A) or “doctor blade” technique (FIG. 3B), setting a spreading gap (between the “die”/“blade” spreading edge and the monofilament fabric) preferably between 50 and 100 μm, up to a maximum of 350 μm.

The spreading is preferably performed by making the supporting fabric slide horizontally (as shown in FIGS. 2, 3A and 3B) but, if particularly viscous solutions are used (from 3000 cP upwards) it could also be carried cut vertically, using the “slot die” technique.

The woven fabric forming the support layer is supplied in rolls (FIG. 2), suitably tensioned, on a “roll to roll” line. In the spreading area a counter cylinder supports the fabric. In this spreading procedure with horizontal sliding of the fabric, the polymer solution is also made to pass through the opposite side of the fabric to that of deposition, going through the meshes of the fabric by percolation; in this way, the fabric is more or less deeply embedded into the final membrane when forming the same (see the different final configurations schematically illustrated in FIGS. 4A-4C). However, to avoid excessive percolation of the polymer solution underneath the woven fabric, the fabric is preferably coupled with a liner—also unwound from a corresponding roll—in an area immediately upstream of the casting phase. The liner is for example a suitably tensioned polymeric film having a thickness of 20-100 μm, which remains close to the fabric during the casting phase and the subsequent inversion phase building the final membrane.

It should be noted that the degree of penetration between the membrane and the fabric (which is therefore at least partly included or embedded in the membrane) depends on the combination of various parameters, such as polymer solution viscosity, fabric thickness and its open area, spreading gap and spreading speed: by suitably adjusting said parameters the desired configuration among those schematically illustrated in FIGS. 4A-4C can be obtained.

The final thickness of the resulting reinforced membrane (wherein the fabric is at least partly embedded) is in the range from 50 to 130 μm, preferably from 50 to 80 μm.

In an alternative casting configuration, with vertical sliding of the fabric, without use of any liner, the solution can be symmetrically laid on both sides of the fabric, so as to embed the fabric to the desired depth in the resulting reinforced membrane. By contrast, the same application method can be performed in the horizontal scrolling by providing a double passage of the fabric under the spreading head or blade, so as to spread the polymer solution on both sides of the woven fabric and obtain coating of both sides and partial embedding of monofilaments into the solution.

The desired porous membrane is formed downstream of the casting, following the further treatments which lead to the phase inversion and the solvent-non-solvent exchange in and from the solution.

Referring to FIG. 2, after the casting phase, the assembly of fabric and polymeric solution is subjected to a phase inversion precipitation procedure for the formation of a porous membrane, in particular in two subsequent steps, namely a VIPS (vapour induced phase separation) followed by a NIPS (non-solvent induced phase separation).

According to the invention, the VIPS phase is provided for the purpose of defining the desired morphology and size of the membrane pores; under different conditions the NIPS process alone can also be used.

After the casting station, the suitably tensioned fabric web with polymer solution is advanced and passes through a climatic chamber (denoted by T,RH in FIG. 2), i.e., a controlled temperature and humidity area, to carry out the VIPS process. In the climatic chamber the temperature is kept between 15 and 60° C., preferably between 2° and 30° C., the humidity is kept at RH 30-95%, preferably RH 50-70%, and a dwell time between 30″ and 10′, preferably between 1 and 4 minutes is provided.

Subsequently, the fabric web coupled with the polymeric solution and possibly the liner advances and enters a coagulation bath, filled with a non-solvent (of polymers) such as preferably water (wherein a small percentage of solvent is optionally dissolved, in the order of 0-10%, for example of Rodhiasolv® Polarclean HSP). An ideal temperature of 20-60° C., preferably of 20-30° C., is maintained in the bath, and the porous structure formation is completed while the composite material advances inside the bath. The phase inversion process is therefore completed inside the coagulation bath, leading to formation of a stable porous membrane firmly attached to the woven fabric.

With this process, a membrane with asymmetric porosity can advantageously be obtained, i.e., with a porous structure having a denser outer skin and a pore size gradient along the thickness. The side with outer denser skin is the one remaining more on the outside in the final application (for example the MEMS package), i.e., the one determining the barrier to fluids. It is not excluded that even a version of the membrane with symmetrical porosity could find use in many applications.

The choice of asymmetric or symmetric membrane has to be tuned to the specific final application of the membrane, inside the MEMS (microelectromechanical system) sensor or microphone.

In particular:
In case of a MEMS microphone, pore size and porosity should be equal on both sides of the membrane; this results in the same air permeability and same acoustic impedance, therefore leading to a balanced insertion loss on the entire period of the sound wave; this allows to avoid any undesired distortion (in particular even-order harmonics distortion, related to asymmetrical resistance);
in case of a MEMS sensor of a smartphone, like a barometer or an altimeter, there's no need of transmitting a rapidly varying periodical sound pressure signal and therefore the above need does not exist; on the other hand, the material could be required to be asymmetrical in terms of air permeability because it needs to be able to both rapidly discharge internal built-in pressure when created (which needs high air permeability, from inside-out) and protect the device from external overpressure if a burst happens (which needs lower air permeability from outside-in).

Therefore, the above process can be customized to provide the desired microporous structure.

According to a preferred embodiment, the membrane average pore size MFP (mean flow pore) is between 0.3 μm and 0.7 μm, its thickness is between 50 μm and 80 μm, which leads to an overall weight of the composite, including the woven fabric, ranging from 20 to 50 g/m².

The asymmetric porous structure of the reinforced composite membrane is generated by exploiting the different demixing/inversion kinetics on the two sides of the coated fabric. As can be understood from the above, the main factors with which the different kinetics and, consequently, the different levels of asymmetry can be controlled are the presence of a support liner on one of the two sides of the fabric, and the fabric entry angle into the inversion/coagulation bath.

It should further be considered that—precisely due to the way its porous structure is obtained—said membrane has a peculiar morphological design deriving from the action of the solvent migrating outwards through the polymeric solution, and from the precipitation/coagulation of the polymeric material: for this reason, the thus obtained membrane can also be defined as having a coagulated porous structure.

The “roll to roll” process, provides for the composite reinforced membrane web leaving the coagulation bath to enter one or more successive washing baths, filled with water, in order to remove any solvent and/or contaminant residues. The washing occurs at a temperature of 20-60° C., preferably 40-50° C., for a period of 30″-10′, preferably 1-4 minutes.

Before rewinding the composite reinforced membrane web into a reel of reinforced membrane, the liner is removed—or, alternatively, it can be removed immediately after the NIPS phase—and the composite reinforced membrane web is dried in a drying station where a fan oven or IR lamps are provided, at a temperature ranging from 60 to 130° C., for the time it takes for the washing water to evaporate.

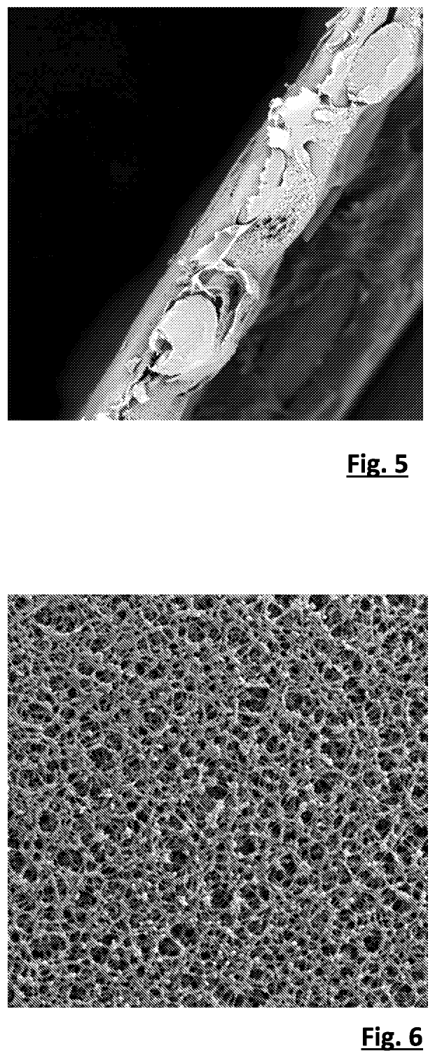

In FIGS. 5 and 6 are high magnification photographs of the finished composite reinforced membrane. In the section of FIG. 5 the polymeric monofilaments embedded in the porous matrix of the polymeric membrane obtained by phase inversion can be perfectly identified. It can be noted that the reinforced composite membrane has an asymmetrical porosity: on one side (on the left in the figure) the porous body is thicker above the monofilaments and ends with a denser skin, while on the opposite side the thickness is lower, and the pore size is greater.

According to a preferred embodiment of the invention, the thus obtained reinforced composite membrane, is subsequently subjected to a surface treatment by plasma deposition of a polymeric coating of nanometric thickness on the exposed surfaces of the membrane.

In particular, the composite reinforced membrane is arranged inside a plasma treatment chamber, in the presence of a gas forming the aforementioned coating. For purposes of the requirements herein set out, gases based on fluorocarbon acrylates, for example heptadecafluorododecyl acrylate, perfluorooctyl acrylate and the like, have proved to be advantageous. In particular, thanks to this selection of gases for plasma treatment, fluorocarbon acrylates can be deposited on the composite membrane, which provide for an excellent water- and oil-repellent action. In the plasma treatment described above a carrier gas can also be used, as known in the literature.

The polymeric coating of nanometric thickness, obtained by plasma deposition technology, can be as thick as 500 nm and, thanks to the particular technology used, it takes the structure of a continuous film, capable of coating even complex and 3D surfaces such as those of the reinforced porous membrane of the invention. Depending on the chemistry used, the polymeric coating can possess, in addition to hydrophobicity and oleophobicity, also antistatic characteristics.

As mentioned above, the most advantageous plasma treatment gases have been shown to be obtained from the following chemical compounds:
1H,1H,2H,2H-HEPTADECAFLUORODECYL ACRYLATE (CAS no. 27905-45-9, H₂C═CHCO₂CH CH₂ (CF₂) 7CF₃)
1H,1H,2H,2H-PERFLUOROOCTYL ACRYLATE (CAS no. 17527-29-6, H₂C═CHCC₂CH₂CH₂ (CF₂)₅CF₃)

In the here contemplated specific application of venting devices, the coating thickness is preferably kept in the range of 15-60 nm, so as to avoid that an excessive coating thickness unduly restrict the membrane pores, which would hinder a desired air permeability.

Tests were carried out on the composite reinforced membrane as such compared to a similar membrane subjected to plasma treatment. The air permeability measurements before and after plasma treatment were the same and equal to 18 l/m² at 1000 Pa. However, the presence of the coating obtained by plasma treatment results in a substantial increase both of the contact angle with water (from 90° to 130°), and of the contact angle with oil (from 50° to 120° for an oil such as corn oil with surface tension of 32 mN/m), wherein the contact angle is measured on a drop of water or oil using the sessile drop technique with a Kruss tensiometer (droplet deposition and measurement of the contact angle by means of a high resolution camera).

According to a further embodiment of the invention, after manufacturing of the reinforced composite membrane and deposition of a polymeric coating by plasma treatment, a second phase of plasma treatment is provided, exposing the reinforced membrane coated with the polymeric layer to a carrier gas alone and therefore in the absence of the formation gas of the aforementioned polymeric coating. In this way, the membrane can be given not only the desired degree of water and oily liquid repellence but, at the same time, also an excellent level of adhesion with a subsequent layer of PSA (provided in the subsequent assembly of the die cut component).

In this second phase of plasma treatment, with carrier gas alone, an adequate work pressure of about 10-400 mTorr, a power at the electrodes of 100-2000 W, and an exposure time from 5 seconds to 5 minutes are set inside the treatment chamber. The carrier gas is preferably selected from nitrogen, helium, argon or oxygen.

In this second phase, given to the inert nature of the gas used, the material which makes the membrane does not undergo any further coating process. The carrier gas ions formed during the plasma treatment impact instead, with a certain content of energy, on the surface of the coating deposited in the previous phase, resulting in a partial etching and reactivation process on the same which generates surface irregularities, for example in the form of micro-corrugations or nano-grooves, which favour the adhesion of the polymer coating to the subsequent layer of PSA.

Although the ionic attack experienced by this polymer coating impairs its continuity, consequently modifying its surface energy value and thus slightly reducing the level of repellence to water and oils of the reinforced composite membrane, it conversely significantly increases the adhesion force of the same reinforced membrane to the layer of PSA which is needed in the assembly of the die cut part. A satisfactory compromise between water/oil repellent behaviour and workability of the reinforced membrane is therefore obtained, which allow to obtain a die cut part and corresponding venting device with excellent performance, considering that in the assembled product the adhesion of the die cut part to the MEMS sensor package significantly contributes to the overall performance of the venting and protection device.

The reinforced membrane without application of the supplementary treatment allows to obtain a very high contact angle value with oil (130-135°), to which the prior art normally associates a very low value of adhesion with a PSA, which therefore compromises the correct bonding and the ease of assembly of the die cut part.

Conversely, the reinforced membrane manufactured according to the invention offers an excellent outcome. In the table below the values of contact angle and adhesion with a PSA with only plasma polymeric coating and with the subsequent second etching plasma treatment in the presence of Helium as the carrier gas are shown, with a vacuum level of 100 mTorr, a power at the electrodes of 700 W and an exposure time of 2 minutes:

| | Contact | Level of |
|---|---|---|
| | angle | adhesion |
| | with | with PSA |
| | oil (°) | (gf/20 mm) |
| membrane + plasma | 130-135 | 20 |
| deposition | | |
| membrane + plasma | 115 | 220 |
| deposition + plasma | | |
| treatment of the | | |
| coating deposited in | | |
| the previous stage | | |

wherein “gf/20 mm” is the value in grams of the adhesion force of the reinforced composite membrane on a 20 mm wide PSA sample.

From these results it can be seen that, downstream of the second phase, or supplementary phase, of plasma reactivation of the polymer coating formed in the previous phase, the thus obtained reinforced composite membrane can achieve both very high contact angle values with oil (>110°), and a level of adhesion with PSA much higher than the minimum required of 100 gf/20 mm.

According to a further embodiment of the invention, the fabric of polymeric monofilaments is subjected, before the casting phase, to reactivation of the monofilament surfaces by means of a plasma treatment in the presence of carrier gas alone. For example, the treatment is carried out in the chamber maintained at a pressure of about 10-400 mTorr, with a power at the electrodes of 100-2000 W, and an exposure time from 5 seconds to 5 minutes, in the presence of a gas carrier preferably selected from nitrogen, helium, argon or oxygen. Depending on the type of gas used, the exposure time, and the power, a more or less pronounced etching effect is obtained, which originates a nano/micro-roughness on the monofilament surfaces, which in turn improves the adhesion with the subsequent polymer solution which will form the porous membrane at the end of the phase inversion process.

The material obtained after the plasma treatment shown here has a WCA (water contact angle) >130°, an OCA (oil contact angle) measured with 32 mN/m oil surface tension >115° and a surface free energy <10 mN/m.

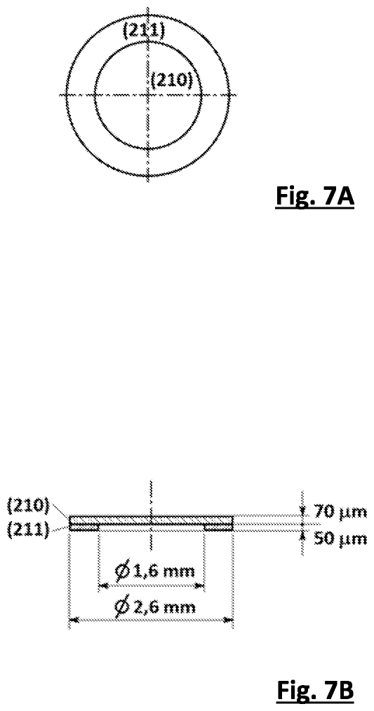

The composite reinforced composite membrane according to the invention can then be advantageously assembled into a die cut part as shown in FIGS. 7A and 7B. In the illustrated practical case, the composite device 210 formed by the hydrophobic reinforced membrane above is cut into a circular shape and coupled with a circular rim 211, made of waterproof double adhesive layer suitable for withstanding high temperatures (typically over 250° C.), applied to the side of the membrane intended to be adhered to the entrance port of the MEMS sensor package.

Exemplary features of said die cut part are:
Reinforced composite membrane according to the invention with a thickness of 70 microns;
Circular active area of the reinforced composite membrane having a diameter of 1.6 mm;
Double PSA layer for HT (“High Temperature”) use: cellulose-based acrylic or 50 micron thick non-woven fabric;
Double PSA single rim, having external diameter of 2.6 mm.

This component is preferably coupled to an easy-release liner to ensure a simple final assembly operation even in the case of an automated process (with “pick&place” robots).

The invention, in its embodiment described herein, has been subjected to laboratory measurements in order to verify its performance features.

The die cut parts, made with the reinforced composite membrane of the invention, with hydrophobic plasma treatment, showed a resistance to pressurized water >500 mbar for 30′, suitable for application on devices such as IP68 class waterproof smartphones. Furthermore, an airflow rate of 36 ml/min at 1 kPa was measured, sufficient to ensure pressure equalization during the reflow cycle, and also a rapid pressure equalization for immediate sensors response in use, aligned with the desired requirements.

Finally, thanks to the arrangement of the reinforced membrane according to the invention and to the excellent adhesion with the PSA, a stiffness of the die cut part of over 25 N/mm (on a 10×10 mm specimen) can be achieved, which is reflected in a high bending rigidity (bending rigidity <10⁻⁶ mm³/Pa), calculated on a circular part with a 1.5 mm diameter.

This last feature, which in itself is adequate for the desired requirements, has been further validated in terms of effects on the acoustic impedance of the die cut part.

To this end, the complete die cut part was measured in terms of complex acoustic impedance, to verify its performances in terms of pressure signal transmission, with the aim of verifying that its superior stiffness contributes to drastically decrease the signal transmission by vibration of the membrane itself, which would make it possible to reduce medium-high frequency disturbances (something the prior art venting components fails to guarantee).

The complex acoustic impedance measurement, performed on a dedicated impedance tube, entails that the die cut part, made with the protective composite reinforced membrane according to the invention, is stressed by a sound source close to one of the two sides, throughout the frequency range of interest (in the specific case, from 20 Hz to 10 kHz). A pair of microphones was arranged to measure the pressure signal before and after the membrane, calculating its transfer function through the membrane, to derive its complex acoustic impedance.

For the venting applications considered herein, a resistive behaviour as constant as possible as the frequency varies is desired, to effectively dampen high-frequency disturbances. The reactive part of the impedance (imaginary part, i.e., reactance), on the other hand, must be as limited as possible and do not dominate the overall behaviour of the membrane. If this were not the case, the material would exhibit strong resonances, at which high-frequency disturbances would not be damped.

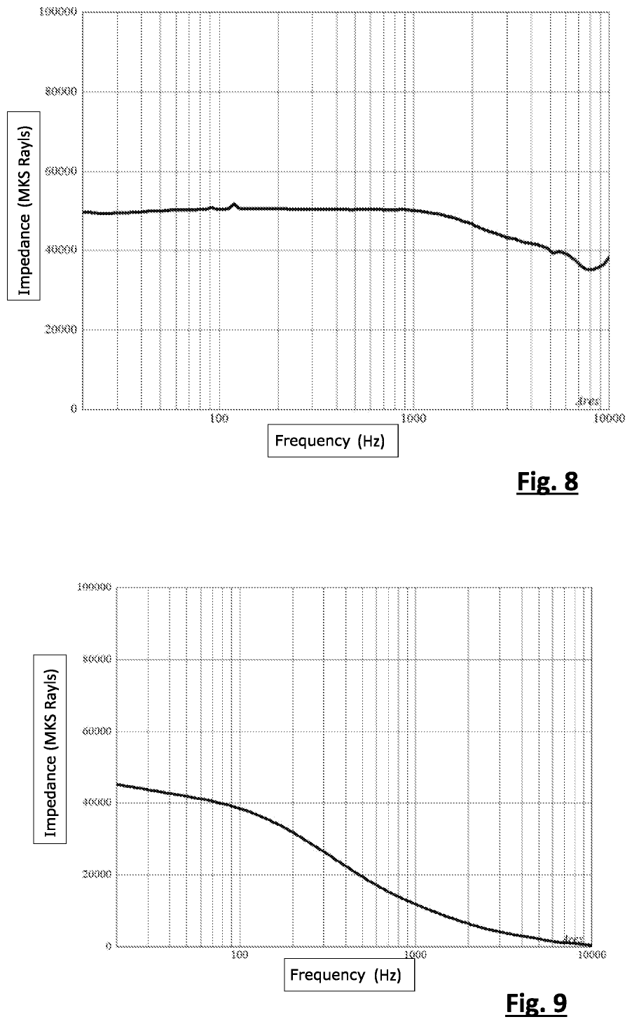

FIGS. 8 to 11 show the plots of the complex acoustic impedance measured as a function of the frequency, relative to the die cut part of the present invention, with an active area diameter of 1.6 mm, compatible with a typical installation on a MEMS sensor package. These findings are then compared with the curves deriving from the measurements on a sample of the prior art, having the same active area and made with a self-standing nanofibre membrane. The acoustic impedance data were expressed both as absolute value (magnitude) and as real and imaginary components of the complex acoustic impedance.

In detail, the plots refer to:

FIG. 8— Magnitude values of a hydrophobic reinforced membrane of the present invention,

FIG. 9— Magnitude values of a self-standing membrane of the prior art;

FIG. 10— Real (solid line) and imaginary (dashed line) components of the hydrophobic reinforced membrane of the present invention;

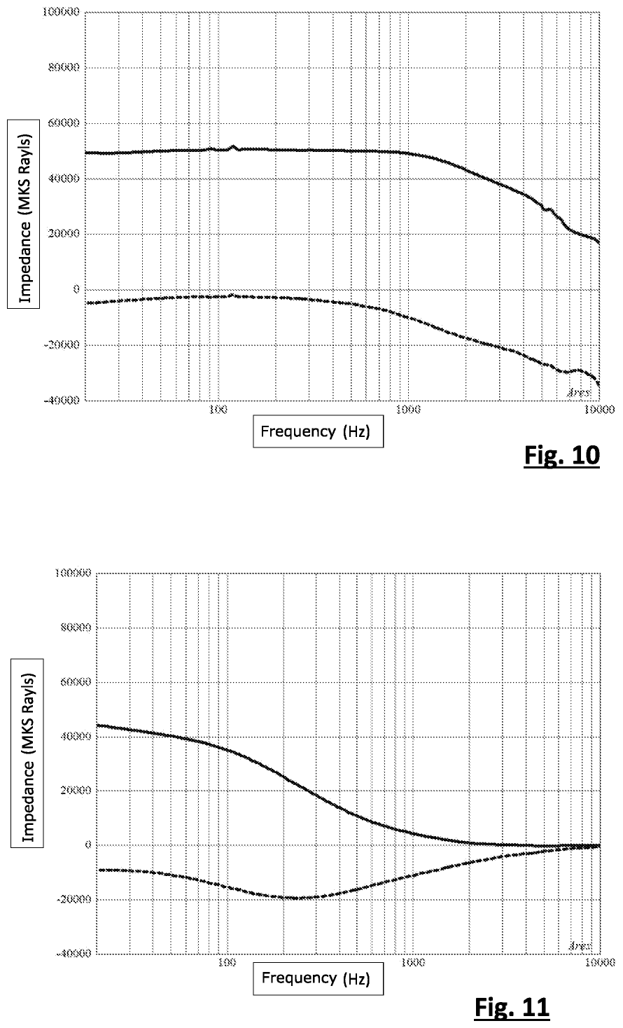

FIG. 11— Real (solid line) and imaginary (dashed line) components of a self-standing membrane of the prior art.

From these findings the effectiveness of the present invention can be clearly inferred. The first two plots (magnitude) demonstrate that, by increasing to a frequency of 1 kHz, the membrane according to the invention keeps its impedance value unchanged, while the prior art is reduced to about 30% of the initial value, losing much of the capacity of dampening pressure signal disturbances. Indeed, at 10 kHz the prior art component has lost about 99% of its acoustic impedance and damping capacity, thus getting to operate at a frequency close to its resonance. Under the same conditions, the die cut part of the invention loses only 20-30% of its acoustic impedance and maintains suitable damping features of high-frequency disturbances. This is due to the predominantly resistive behaviour connected to the superior flexural stiffness, guaranteed by the novel composite structure of the reinforced membrane.

The plots of the real and imaginary acoustic impedance components give more details of the above. It should be noted how the die cut part of the invention exhibits an imaginary part close to zero, up to 1 kHz, maintaining the prevalence of the resistance over the reactance even for higher frequencies. All of this is optimal for use as a protective venting device for MEMS pressure sensor. On the contrary, the prior art component unequivocally demonstrates a resonance close to 10 kHz, when the imaginary part of the impedance tends to zero, to then become positive at higher frequencies, while also the real part is reduced to minimum values. In these conditions, the die cut part of the prior art is not capable of effectively damping unwanted disturbances on the pressure signal. Its use associated with a MEMS pressure sensor would therefore lead to unsatisfactory results, contrary to what occurs for the membrane according to the present invention.

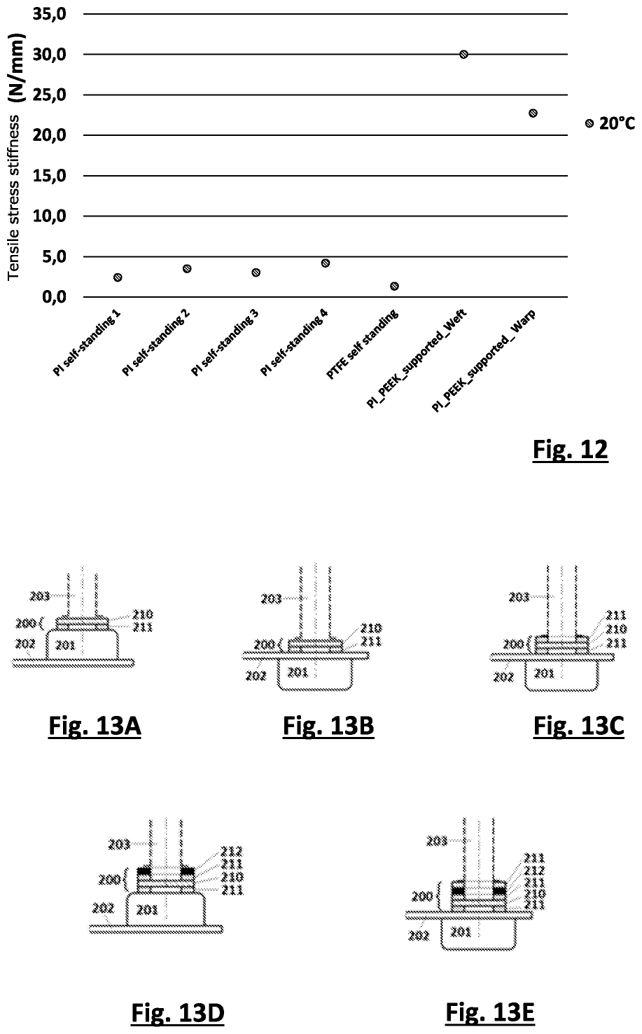

The plot of FIG. 12 shows the stiffness values of some venting devices according to the prior art, compared with the venting device according to the invention in the preferred embodiment made of Peek fabric and PI polymer solution. The latter—identified by the last two data on the right of the plot—shows significantly higher values at operative temperature, without however softening in the reflow conditions.

In FIGS. 13A-13E different ways of assembling the die cut part of the invention on the port of a MEMS sensor package are represented, wherein the numerical references indicate the same elements of FIGS. 7A and 7B. In particular, (200) refers to a die cut part having reinforced and hydrophobic membrane made according to the invention, (201) refers to the MEMS sensor, (202) refers to the MEMS flex/PCB, (203) refers to the position of the external channel of the electronic device, (210) refers to the heat resistant hydrophobic reinforced composite membrane, (211) refers to a heat resistant PSA double rim, and (212) refers to a high temperature polymer stiffener.

The die cut venting device can therefore be supplied with a PSA rim on one or both sides of the reinforced composite membrane. The polymer stiffener preferably has a thickness of <100 microns which does not cover an active area of the membrane, i.e., the area free from fittings, which performs the venting function. Optionally, an additional layer of synthetic or metal fabric can be provided, with primarily aesthetic functions or as coarser protection against particles, with mesh opening >20 micron, and equipped with a corresponding additional PSA rim.

As can be understood from the above description, the composite membrane and corresponding venting device according to the invention allows to perfectly achieve the objects set out in the introduction. The materials of which it is made, the geometric and spatial structure, as well as the specific manufacturing and treatment process, allow to obtain a venting device which performs excellently in the considered critical applications. In particular, said reinforced membrane can be optimally assembled to provide a die cut part which lends itself perfectly to be used as a protection venting device for MEMS pressure sensors, a field wherein the requirements are particularly tight.

Monofilament mesh has a very defined geometry when compared with a multifilament fabric. Thank to this, monofilament mesh can offer the optimal geometrical feature for the adhesion of the phase inversion membrane. In particular:
the thickness of the monofilament woven mesh is equal to two times the diameter of the monofilament yarn with good approximation; this choice determines the thickness needed to the membrane to embed the mesh and can be optimized for this task;
in combination with the above thickness, the mesh opening figure determines the amount of solution the mesh is able to receive and though the features of the final membrane obtained;
for monofilament mesh only the value open area can be mathematically obtained starting from the mesh count and mesh opening measured in both warp and weft directions; therefore, the right choice of mesh count and thread diameter allows to get the ideal open area for embedding the phase inversion membrane.

In a multifilament fabric, none of the above features can be defined precisely and therefore can't be optimized for the above process.

In particular, the solution provided by the invention makes it possible to achieve complete satisfaction of the process and functional requirements listed above, i.e.:
Resistance to liquid intrusion, class IPx7, IPx8;
Resistance to particle intrusion 99.99% at 1-5 μm;
Air permeability >10 l/m² at 1000 Pa, necessary to guarantee a quick pressure equalization time considering MEMS package ports with diameter of 0.5-2 mm;
Air permeability >10 l/m² at 1000 Pa, necessary to compensate for the pressure increase generated by heating of the internal air, during the reflow cycle in the assembly of MEMSs;
Behaviour to the transfer of pressure signals of a purely resistive (passage of air) and non-reactive (vibration of the part) nature, necessary to guarantee the correct functioning of a pressure sensor;
Bending rigidity <10⁻⁶ mm³/Pa for the design sizes in the MEMS field (diameter 1.6 mm);
Sensor response time <0.2 s under design conditions in the MEMS field (port area 2 mm², internal volume 0.4 mm³).

It should also be noted that the preferred embodiments of the invention also make it possible to obtain excellent adhesion of the membrane body to the support layer consisting of the monofilament fabric, as well as of the composite device with PS adhesives, which avoids delamination and/or air leakage problems, thus achieving the desired venting performances and an excellent life span.

However, it is understood that the invention is not limited to the particular configurations illustrated, which are non-limiting examples of the scope of the invention, but that several variants are possible, all within the reach of a person skilled in the art, without thereby departing from the scope of the invention itself as defined in the attached claims.

1. A venting composite membrane, comprising
a supporting woven fabric made of woven polymeric monofilaments, and
a membrane attached to said supporting fabric,
characterized in that
said supporting woven fabric is at least partly embedded in said membrane, and
said membrane is a polymeric membrane having a coagulated porous microstructure.

2. The venting composite membrane as in claim 1, wherein said monofilaments of the supporting fabric are made of a polymer selected from PEEK, PEK, PEKK, PTFE, PI, PFA, FEP, PPS, PEI, PBI, PCTFE, ECTFE, PAI, PPSU, preferably PEEK.

3. The venting composite membrane as in claim 1 wherein the ratio of open area of the supporting fabric is at least of 30%, and less than 75%.

4. The venting composite membrane as in claim 1, wherein the thickness of said supporting fabric is in a range of 40-120 μm, preferably 40-70 μm, with a thickness of the individual monofilaments between 30 and 40 m.

5. The venting composite membrane as in claim 1, wherein said polymeric membrane is based on a polymer selected from polyimide (PI), S-PEEK, PES, S-PES, PPS, PAI, PBI.

6. The venting composite membrane as in claim 1, wherein said polymeric membrane having a porous microstructure has an asymmetrical porosity, with denser outer skin on one side only.

7. The venting composite membrane as in claim 1, wherein said polymeric membrane has a mean flow pore (MFP) size between 0.3 and 0.7 μm and a thickness between 50 and 80 μm and a weight between 20 and 50 g/m².

8. A manufacturing method of a venting device with composite structure, comprising at least
coupling a supporting woven fabric made of polymeric monofilaments with a polymeric porous membrane,
characterized in that it includes
arranging a solution of polymers and a solvent,
spreading by casting said solution onto said supporting woven fabric, causing at least partial penetration of the solution into a mesh of said supporting woven fabric and obtaining an assembly,
subjecting said assembly of supporting woven fabric and polymer solution to phase inversion coagulation process at least in a bath of non-solvent, to obtain a reinforced membrane having a coagulated porous microstructure,
subjecting said reinforced membrane having a coagulated porous microstructure to a surface treatment by plasma deposition of a polymeric coating with a nanometric thickness in the range of 15-60 nm apt to impart to a surface of the reinforced membrane properties of contact angle with water from 900 to 130° and a contact angle with oil from 50° to 120°.

9. Manufacturing method as in claim 8, wherein said solution includes
polymers selected from polyimide (PI), S-PEEK, PES, S-PES, PPS, PAI, PBI, and
solvent selected from the solvents of water-soluble resins, such as N-methyl-2-pyrrolidone (NMP), N-ethylpyrrolidone (NEP), N,N-dimethylformamide (DMF), N,N-dimethylacetamide (DMAc), dimethylsulfoxide (DMSO), Dihydrolevoglucosenone (Cyrene), Rodhiasolv® Polarclean HSP, γ-butirrolactone (GBL), ethyllactate, triethylphosphate (TEP), gammavalerolactone (GVL), dimethyllactamide, Tamisolve® NxG, acetonitrile, N,N-dimethyllactamide (DML).

10. The manufacturing method as in claim 8, wherein said solution of polymers and corresponding solvent has an initial polymer weight up to 25%, preferably between 6% and 12%.

11. The manufacturing method as in claim 8, wherein said spreading-by-casting step is carried out on one side of said supporting woven fabric which is coupled, on the opposite side, with a liner.

12. The manufacturing method as in claim 8, wherein said phase inversion coagulation step is carried out in two steps through a VIPS phase (vapour induced phase separation) followed by a NIPS phase (non-solvent induced phase separation).

13. The manufacturing method as in claim 8, wherein a second step of plasma treatment is carried out, exposing said reinforced membrane to a carrier gas only, within a treatment chamber wherein a work pressure of about 10-400 mTorr, a power at the electrodes of 100-2000 W, and an exposure time from 5 seconds to 5 minutes are set, and wherein said carrier gas is selected from nitrogen, helium, argon or oxygen.

14. A venting device to be applied to a MEMS sensor package, comprising a reinforced membrane manufactured through a method as in claim 8, die cut according to a desired shape and coupled with at least one PSA rim.

15. The venting device as in claim 14, wherein said PSA rim is coupled to a stiffening layer in the shape of a ring of polymeric material of <100 microns thickness which does not cover an active area of the reinforced membrane.
